(19) United States
(12) Patent Application Publication
(10) Pub. No.: US 2019/0037273 A1
(43) Pub. Date: Jan. 31, 2019

(54) CONTENT DELIVERY USING LOCATION AWARENESS

(71) Applicant: Amino Communications Limited, Swavesey (GB)

(72) Inventor: Joseph Thomas ROSS, Stevensville, PA (US)

(21) Appl. No.: 15/664,934

(22) Filed: Jul. 31, 2017

(51) Int. Cl. H04N 21/45; H04N 21/258; H04N 21/81; H04N 21/44; H04N 21/4402; H04N 21/433

(52) U.S. Cl. CPC H04N 21/4524; H04N 21/25841; H04N 21/433; H04N 21/44016; H04N 21/4402; H04N 21/812

(57) ABSTRACT

Disclosed herein are methods for a content delivery network client to provide location- and user-based data to a content delivery network in order to receive location- and user-based content from the content delivery network. In some embodiments, the location- and user-based content is used to modify a content stream provided to the content delivery network client by the content delivery network. In some embodiments, a content delivery network client manipulates a manifest file in order to provide the location- and user-based data to the content delivery network.

### BACKGROUND

The following disclosure relates to the field of digital content delivery.

Digital content, such as a television program, has historically been delivered by way of in-home digital set-top boxes (STBs). While technological advances to set-top boxes and more ubiquitous high-speed network connections have allowed for increased network-based delivery of both program and advertisement content, there still exists a large installed base of set-top boxes that rely on over-the-air (OTA) delivery of program and advertisement content. In fact, as consumers increasingly look to “cut the cord,” i.e., move away from traditional content providers, there may be an actual increase in over-the-air content delivery over time.

An issue with over-the-air content from the perspective of a content delivery network (CDN) looking to provide targeted advertisements is that the over-the-air data connection is a one-way data connection. In other words, set-top boxes receiving over-the-air content do not have a way to pass back data about a user's location or usage behavior via the over-the-air connection. Consequently, content delivery networks rely on course targeting of advertising, such as defining regions wherein content is delivered over-the-air with region-specific advertisement content added into the content streams. But course targeting misses many of the opportunities that are available where a content delivery network knows the location of a set-top box and information about the user of the set-top box, such as the ability to deliver finely targeted advertisement to that set-top box and user.

Accordingly, there is a need for methods of delivering targeted advertisement content to users receiving their content via over-the-air connections.

### SUMMARY

Embodiments described herein provide a system to for providing location- and user-based content to content delivery network clients, such as set-top boxes, in a content delivery network. Embodiments of a content delivery network client, such as a set-top box, may request location data from local resources, such as a local network device, and thereafter provide the location data to the content delivery network so that location-based content may be provided to the client. In some embodiments, a content delivery network client may receive a manifest file from a content delivery network and thereafter modify the manifest file in order to obtain location- and/or user-based content. The location- and/or user-based content may subsequently be inserted into a content stream provided by the content delivery network to provide a user with personalized experience. In some embodiments, the location- and/or user-based content may be targeted advertisement or promotional content.

### BRIEF DESCRIPTION OF THE DRAWINGS

FIG. 1 depicts aspects of a content delivery network.

FIG. 2 depicts an embodiment of a method performed by a content delivery network client in a content delivery network.

FIG. 3 depicts an embodiment of another method performed by a content delivery network client in a content delivery network.

### DETAILED DESCRIPTION OF CERTAIN INVENTIVE EMBODIMENTS

### Overview of a Content Delivery Network

Generally speaking, a content delivery network (CDN) intakes or ingests video and audio program content from one or more original content sources, processes the ingested content, and then transmits the processed content to consumers (e.g., listeners, viewers, or other types of users). The original content may include, for example, video or audio program content and other video content provided by a Multiple System/Service Operator (MSO) or a regional or national network.

Content provided in a content delivery network may be linear or nonlinear. Generally, linear content is scheduled and provided by broadcast at or near real-time, e.g., by transmission in a linear content stream to a content delivery network client, such as a set-top box (STB). Traditional television content, such as a live sporting event, is an example of linear content. Nonlinear content, on the other hand, is stored by the content delivery network and provided “on-demand” to users. As such, non-linear content may be transmitted over broadcast or unicast, for example over a broadband internet connection.

A content delivery network may include a content preparation subsystem configured to ingest and process content prior to transmission. The content preparation subsystem may control ingestion of content from linear content sources, such as satellite or fiber feeds, as well as from non-linear sources, such as local and remote storage systems. To control ingestion of content, the content preparation subsystem may have information about what content is to be ingested from what source, as well as where and when any content may become available for ingestion.

This content preparation subsystem may further be configured to decode ingested content, transcode the content, encrypt the content, remove advertising from the content, insert advertising into the content, and perform other processing before providing the content to users. For example, the content preparation subsystem may be configured to control repackaging of the ingested content into one or more individual files. As another example, the content preparation subsystem may be configured to ingest content in a first format and then transcode it to a second format. For example, transcoding may change the underlying format of an ingested video to a preferred format, such as H.262/MPEG-2, H.264/MPEG-4, H.265/HVEC/MPEG-H, or other video standards. Transcoding may also change characteristics of the content, such as changing the aspect ratio, frame rate, progressive sequence, color profile, sound encoding, etc. of the ingested video. Thereafter, the content preparation subsystem may be configured to encrypt the ingested and processed content.

The content preparation subsystem may also be configured to strip or remove advertising and promotional content from the ingested content as part of the processing. The content preparation subsystem may also insert advertising or promotional content into the ingested content. For example, the content preparation subsystem may insert targeted advertising and promotion content into the ingested content where the original advertising and promotion content is removed or is absent.

In some embodiments, the content preparation subsystem may customize or personalize advertisement content based on a user's location and/or preferences or target specific types of users for advertising.

In some embodiments, the content preparation subsystem performs both removal and insertion of advertising and promotion content. In other embodiments, a content delivery network client, such as a set-top box, may perform the insertion of the targeted advertising and promotion content. In yet other embodiments, a content delivery network client may perform removal of original advertisement content and insertion of targeted advertisement content.

A content delivery network may also include a storage subsystem configured to store ingested content. The storage subsystem may be configured to store processed content in the form of files (e.g., television programs, movies, performances, etc.) or in a database storing individual program content or assets for retrieval. In some embodiments, an expiration time may be associated with stored content such that the stored content will automatically be deleted after a certain amount of time has elapsed.

A content delivery network may also include a content management subsystem configured to maintain ingested content and metadata associated with the ingested content as well as to maintain compliance and digital rights management. For example, the content management subsystem may store information about stored content such as type of content, encoding format, file size, content playback length, etc. In some embodiments where the content is stored in one of multiple possible locations, the content management subsystem stores the locations of where different content may be retrieved.

In some embodiments, the content management subsystem stores information about the stored content in metadata associated with the stored content, and is further capable of inputting and editing metadata for stored content. In some embodiments, metadata is associated with both linear and nonlinear content. For example, the metadata may include tags corresponding to content attributes such as content identification (ID), show or movie or episode titles, channel, cast members, genres, program description, plot, and others. In some embodiments, a content delivery network client uses the metadata to categorize and describe the content to a user, or to enable a viewer to search for available content.

The content management subsystem may be further configured to manage digital rights and encryption keys associated with stored content. For example, the content management subsystem may manage the distribution of decryption keys to, for example, content delivery network clients, so that the content delivery network client may decrypt and display the content to a user.

A content delivery network may also include a programming control subsystem configured to control how certain content is distributed and presented to viewers. For example, the programming control subsystem may allow selection of content to be provided to a selected user base, such as a particular geographic user base. Further, the programming control subsystem may highlight newly acquired content or promote special events, such as sporting events to users.

A content delivery network may also include a content distribution subsystem configured to distribute content to users. The content distribution subsystem may transmit content via multiple forms of delivery, such as broadcasts, including satellite and terrestrial broadcasts, as well as via streaming over a network such as the Internet. In some embodiments, the content may be broadcast using the Advanced Television Systems Committee (ATSC) digital television standard. The content distribution subsystem may also include a series of servers and storage elements deployed across a network, such as the Internet, in order to optimize delivery of content to content delivery network client, e.g., to set-top boxes. In some embodiments, these servers may be referred to as “origin servers,” “edge servers,” “proxy servers,” “cache servers,” or the like. In some embodiments, the broadcasts may include content other than video and audio content, such as control information, content schedules, and software updates.

The content distribution subsystem may further be configured to create and maintain a schedule for content delivery by broadcast transmission and unicast transmission to content delivery network clients. For example, the content distribution subsystem may schedule delivery of both linear content and nonlinear content to users at particular times and/or in particular places. In some embodiments, the content distribution subsystem may determine the transmission routes in which content is to be transmitted for both linear and nonlinear content. For example, the content distribution subsystem may determine that high-demand nonlinear content is to be broadcast at a specific time, while low-demand nonlinear content is to be unicasted via networks at any time.

A content delivery network may also include an analytics subsystem. The analytics subsystem may, for example, collect user or operational data transmitted from content delivery network clients, such as set-top boxes. User or operational data may include, for example: ratings for content; records of content that is selected and consumed by users; records of content that is ignored by users in process of finding content which is ultimately selected and consumed; records of content subscribed to on a regular basis; records of program content requested for one time viewing; and others. The data collected by the analytics subsystem may be used, for example, to match specific content to an individual user's interests and preferences.

A content delivery network may be in communication with independent networks, such as affiliate networks, which own or control independent broadcast systems.

In other embodiments, a content delivery network may include more or fewer subsystems and/or components than described, above. In some embodiments, a content delivery network may be referred to as a content provider.

### Content Delivery Network Clients

A content delivery network client may be embodied in many forms, including set-top boxes, which may also be referred to as receivers or receiver controllers. A content delivery network client provides a user with access to content provided by a content delivery network. In some embodiments, a content delivery network client may include: a processor, a memory, software, firmware, an antenna subsystem, a network subsystem, one or more tuners, a content storage subsystem, a digital rights and encryption key subsystem, a metadata and file management subsystem, a content playback subsystem, a personalized content subsystem, an advertisement content subsystem, and a user interface.

An antenna subsystem of a content delivery network client may be configured to receive broadcast transmissions from terrestrial and satellite-based broadcast networks. In some embodiments, the antenna subsystem may include an antenna that is configured to facilitate reception of digital television signals in, for example, the upper VHF and UHF bands, according to, for example, the ATSC standard. In other embodiments, this antenna subsystem may include a networked antenna system transport unit (NATSU) that is physically separated from the content delivery network client, but which is coupled to the content delivery network client via a local network.

A network subsystem of the content delivery network client may be configured to control the communication interface(s), including wired and wireless network interfaces, with local and wide area networks, such as the Internet, or other networks. For example, the network subsystem may control the reception of unicast content over a broadband distribution network associated with a content delivery network. The network subsystem may also control reception of system control messages, exchange of analytical data, and reception of software updates from the content delivery network. The network subsystem may also control communication between content delivery network clients, such as between set-top boxes connected to the same local area network.

A tuner of a content delivery network client may be configured to receive linear and/or nonlinear content from the content delivery network via broadcast or unicast transmission. In some embodiments, a schedule received from the content delivery network determines a channel and time for the tuner to capture desired content. In some embodiments, a tuner may be in a continuous reception mode in which broadcast content is opportunistically stored in a local storage, such as a local hard drive. The tuner may also be configured to interact with a user interface of the content delivery network client in order to allow a user to select content for consumption. In some embodiments, a content delivery network client may have more than one tuner. In embodiments where there are multiple tuners, a user may, for example, simultaneously view live content while also recording other live content using another tuner.

A content storage subsystem of a content delivery network client may be configured to store linear and nonlinear content on local storage media, such as a hard drive, flash memory, or any physical storage component. In some embodiments, the content storage subsystem may have access to external storage device, such as external hard drives, that are coupled to the content delivery network client and serve as either a primary or secondary source of content storage. In addition to storing linear and nonlinear content, the content storage subsystem may also store targeted advertisement and promotional content that are transmitted from the content delivery network or other network sources.

The content storage subsystem may also be configured to manage the disk and storage space of the content delivery network client. In some embodiments, the content storage subsystem may control the deletion of stored content.

A digital rights and decryption subsystem of a content delivery network client may act as the counterpart of the rights and encryption key function in the content delivery network. The digital rights and decryption subsystem may be configured to receive digital decryption keys transmitted from the content delivery network for decrypting content that is received from the content delivery network. In some embodiments, the digital rights and decryption subsystem communicates closely with its counterpart for transmission of decryption keys. In some embodiments, the encryption and decryption keys are associated with digital rights management. For example, digital viewing rights of certain content may be set for expiration for a particular period after the content is received from the content delivery network. Once the period expires, the content may no longer be decrypted with the decryption key that was transmitted to the digital rights decryption subsystem of the content delivery network client. In some embodiments, the expired decryption keys and the associated content may be deleted automatically. In other embodiments, the expired decryption keys may either be automatically renewed or a user may request for the expired decryption keys to be renewed.

A metadata and file management subsystem of a content delivery network client may be configured to manage metadata associated with content stored locally on the content delivery network client, including nonlinear content received by broadcast transmission, linear content received from broadcast transmission, and content received via unicast over a network, such as the Internet. The metadata may include tags corresponding to content attributes, such as: content ID, show or movie or episode titles, channel, cast members, genres, program description, and plot. In some embodiments, such metadata is used to by the content delivery network client to correctly categorize and describe the content to the user. In other embodiments, such metadata is used by the content delivery network client to enable a user to search for content on the content delivery network client.

A content playback subsystem of a content delivery network client may be configured to control the playback of content such as television programming, Internet video clips, on-demand movies, etc. In some embodiments, the content playback subsystem supports multiple video formats, including H.262/MPEG-2, H.264/MPEG-4, H.265/HVEC/MPEG-H video encoding formats and others. The content playback subsystem may play back linear content received by the content delivery network client in real time as well as linear and nonlinear content stored in the content storage subsystem of the content delivery network client.

The content playback subsystem may also play back content received over a network connection, such as via the Internet. For example, content delivery network clients, such as set-top boxes, may receive content from Internet streaming services, such as Netflix, over wired or wireless network connections. When a viewer selects a particular program content from such a streaming service, the content is thereafter streamed to the content delivery network client from the content delivery network or from third party services. The streamed content is often fetched by the content delivery network client in predetermined time chunks, or segments, such as two, three, five, or ten second segments (or other segment lengths).

A personalized content subsystem of a content delivery network client may be configured to collect data about a user's behavior and use patterns and to determine viewing preferences for the user. User data may include, for example, viewing behavior, subscriptions for linear and nonlinear content, explicit requests by the viewer to record specific linear content, explicit requests by the user to capture specific nonlinear content, and explicit ratings for specific content, among others.

In some embodiments, the personalized content subsystem may be configured to place content in the user interface based on determined user preferences. Similarly, the personalized content subsystem may cause linear or nonlinear content to be proactively stored based on user activity or preferences, such as when a user has watched consecutive episodes of a particular television program.

An advertisement content subsystem of a content delivery network client may be configured to retrieve and manage the advertisement and promotional content stored in the content delivery network client. In some embodiments, the advertisement content subsystem receives advertising promotional content from the content delivery network. The advertising or promotional content received from the content delivery network may, for example, be targeted based on program content transmitted to the content delivery network client, the location of the content delivery network client, user activity associated with the content delivery network client (e.g., based on historical user data), and others.

In some embodiments, the advertisement content subsystem is configured to both remove and insert advertisement or promotional content. For example, nonlinear content received by the content delivery network client may or may not include advertisement content. If the nonlinear content does include original advertisement content, but the original advertisement content is not targeted to the location or preference of the user, the advertisement content subsystem may remove the original advertisement content, retrieve targeted advertisement content, and then insert the targeted advertisement content into the program content. If the nonlinear content does not have original advertisement content, the advertisement content subsystem may retrieve advertisement content and insert it into the program content.

A user interface of a content delivery network client may interact with a user device, such as a remote control, personal electronic device, smart device (e.g., smartphone), tablet, computer, or the like, in order to execute commands and requests of a user. The user interface may enable a user to select content, enter preferences, enter ratings, schedule recordings, view content, view advertisements, etc.

Notably, the functions of a content delivery network client may be implemented in many device forms. For example, the functions of a content delivery network client may be implemented in a set-top box. In other embodiments, a content delivery network client may be implemented in a card or similar peripheral meant to directly interface with a television or monitor, such as a CableCARD. Alternatively, the functions of a content delivery network client may be implemented in a general-purpose computer, such as a media computer that includes function-specific software and hardware (e.g., tuners). In yet other embodiments, the functions of a content delivery network client may be completely virtualized and connected, for example, to a network-based antenna unit in order to receive over-the-air broadcasts. The concepts taught herein are not limited to one specific device form.

### Ad Placement in Content

Content provided through a content delivery network may be divided into a plurality of time intervals or segments, including intervals reserved for program content, such as a television show selected by a viewer, and intervals reserved for advertisement and promotional content. Intervals reserved for advertisement content may be referred to as advertisement placement opportunities or simply placement opportunities. Historically, placement opportunities were also referred to as “avails” and more recently placement opportunities have been referred to as “slots.” For example, a slot is a placement opportunity into which a “spot” (e.g., an advertisement) may be inserted. Placement opportunities may include definitions or rules that apply to the opportunity, such as its duration, interactivity, ownership, and technical constraints.

In linear content, such as broadcast television, advertisement placement opportunities may be arranged in advance and fulfilled linearly. By contrast, in nonlinear content, such as Video-on-Demand (VOD) content, advertisement placement opportunities may appear based on space, time, content, and user context (i.e., nonlinear).

The SCTE-130 standard provides a standardized and extensible message-based interface for communicating placement opportunities, placement decisions, and placement related event data necessary for accountability measurements. In particular, the SCTE-130 standard defines mechanisms for integrating systems implementing features such as VOD-based advertising, linear-based advertising, enhanced advertising capabilities such as advertisement rotation groups (rotation groups refer to placement opportunities that run in rotation so that the same ad is not viewed again immediately), subscriber-based addressing for advertising or content tailoring, extension points for more advanced advertising or addressing features, logical services that are implemented as one or more physical systems created by the same vendor, deployment of a logical service that may simultaneously include systems from one or more vendors, and an implementation that may incorporate one or more of the defined logical services and interfaces

The SCTE-35 standard provides for signals that indicate advertisement insertion opportunities in a content stream. For example, to identify a particular time when a program has ended and before the next program begins, i.e., a placement opportunity, a “cue tone” is inserted in the content stream at a predetermined time before the next program begins. In some embodiments, the cue tone may be an instance of an SCTE-35 packet. In a content delivery network client, a service, such an advertisement content subsystem, may recognize the indication (e.g., cue tone or packet) and subsequently place one or more advertisements into the content stream. Notably, SCTE-35 is only one example of standard for indicating advertisement insertion opportunities; other standards are equally applicable.

After placing advertisement content into a content stream using, for example, the aforementioned SCTE standards or other similar standards, content providers, such as MSOs, as well as national and local networks, may want to track whether an advertisement has been played for a user. Content delivery network clients have traditionally implemented this feature by building intelligence into the content delivery network. Content delivery network clients may employ a “manifest file” in order to track content delivery, including program content and advertisement content. As used herein, a manifest file, a manifest, or a session manifest, refer to a listing or index of what is contained in each of the segments of a content session maintained by a content delivery network. More particularly, the manifest file may include a list of URLs that respectively point to each segment of a content stream and include metadata regarding the segment, such as the type of content segment: content or advertisement. In some embodiments, manifest files comprise Extensible Markup Language (XML).

When intelligence is built into a content delivery network client, the content delivery network client may: (1) maintain a copy of a manifest file; (2) perform the function of splicing advertisement content into a placement opportunity in a content stream; (3) mark the manifest file for each segment played; and (4) report a proportion of a session (e.g., the number of segments) played to a content delivery network.

The content delivery network may maintain a separate manifest file for each active content session. Conventionally, the content delivery network provides one or more manifest files to a content delivery network client in response to a request from the content delivery network client for the manifest file corresponding to an active content session. In some cases, the request is accompanied by a session identifier. The content delivery network may then retrieve a manifest file based on the session identifier and provide it to the content delivery network client.

### Targeted Content Placement in Over the Air Content Streams

Despite the advancements in network-based delivery of linear and nonlinear content, there is a need for content delivery networks to be able to deliver targeted advertisement content to users receiving their program content via over-the-air connections.

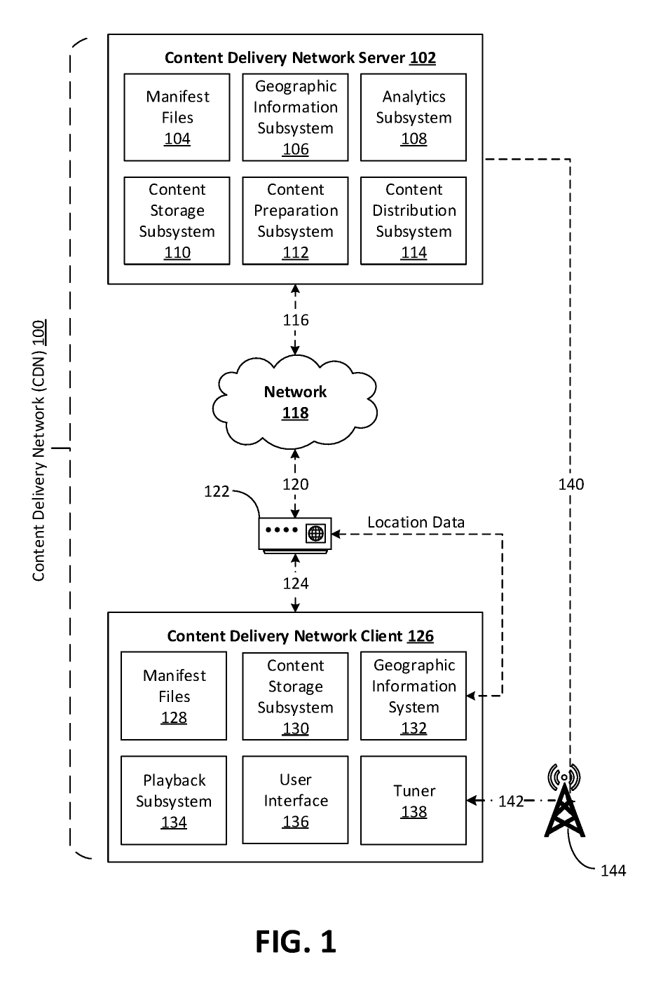

FIG. 1 depicts an embodiment of a content delivery network 100. Notably, not all possible features of content delivery network 100 are depicted in FIG. 1. Rather, a simplified depiction of a content delivery network is depicted to aid in the discussion.

Content delivery network 100 includes a content delivery network server 102, which in some embodiments may be alternatively referred to as an origin server or an edge server. As described above, the content delivery network server may be a part of content distribution subsystem of a content delivery network. As with content delivery network 100, not all possible features of content delivery network server 102 are depicted in FIG. 1. Rather, a simplified depiction of a content delivery network server is depicted to aid the discussion.

Content delivery network server 102 may include a processor, a memory, software, firmware, and hardware necessary to implement the functions described herein.

Content delivery network server 102 includes server-side manifest files 104 that may be configured, for example, to track content delivery, including program content and advertisement or promotional content.

Content delivery network server 102 also includes a geographic information subsystem 106 that may be configured, for example, to determine the location of a content delivery network client based on data received from a content delivery network client.

Content delivery network server 102 also includes an analytics subsystem 108 that may be configured, for example, to receive location and/or user or operational data and determine analytics based on the received data. Example analytics may include: specific content a user consumes; the length of the average content consumption; the average time(s) of consumptions; the types of content the user consumes (e.g., TV shows, movies, music streaming); the genres of content the user consumes (e.g., news); the types of content the user schedules to watch; particular content the user schedules to watch; the types of content the user watches unscheduled; particular content the user consumes unscheduled; the types of sports the user follows; the sports teams a user follows; and many others.

Content delivery network server 102 also includes a content storage subsystem 110 that may be configured to store program content as well as advertising content. In some cases, content storage subsystem 110 may act as short-term storage (e.g., as a buffer) for linear content, while in other cases content storage subsystem 110 may act as long-term storage for nonlinear content (e.g., movies on demand). In some cases, the content in content storage subsystem 110 may be replicated or mirrored from other networked content storage systems, such as other servers associated with the content delivery network.

Content delivery network server 102 also includes a content preparation subsystem 112 that may be configured to strip or remove advertising and promotional content from content and insert advertising into content, including customized or personalized advertisement content based on location and/or user-based analytics (e.g., as determined by analytics subsystem 108).

Content delivery network server 102 also includes a content distribution subsystem 114 that may be configured to distribute content to various users via various means. For example, as shown in FIG. 1, the content delivery network server 102 is configured to distribute content via network 118 as well as via over-the-air broadcast from antenna 144.

Content delivery network 100 also includes a content delivery network client 126. In some embodiments, the content delivery network client is a set-top box. As with content delivery network server 102, not all possible features of content delivery network client 126 are depicted in FIG. 1. Rather, a simplified depiction of a content delivery network client is depicted to aid in the discussion.

Content delivery network client 126 includes its own manifest files 128, which may be delivered initially from the content delivery network server manifest files 104, or otherwise based on the content delivery network server manifest files 104.

Content delivery network client 126 also includes a content storage subsystem 130 that may be configured to store program content as well as advertising or promotional content. In some cases, content storage subsystem 130 may act as short-term storage (e.g., as a buffer) for linear content, while in other cases content storage subsystem 130 may act as long-term storage for linear content (e.g., recorded live television) and nonlinear content (e.g., movies rented on demand).

Content delivery network client 126 also includes a geographic information system 132 that may be configured, for example, to determine the location of content delivery network client 126. For example, geographic information system 132 may receive location data from on-board sensors, such as on-board Global Positioning System (GPS) sensors. As another example, geographic information system 132 may receive location data from a location-aware network device, such as gateway 122 (as depicted in FIG. 1), or other devices or nodes, such as a router, a switch, an access point, a hub, or the like. In some embodiments, the location data may comprise geographical identification metadata, such as a geotag, geostamp, or the like, or other forms of geospatial metadata. The location data may include, for example, latitude and longitude coordinates, altitude, accuracy data, place names, and time stamps.

Because content delivery network client 126 can determine its location, either intrinsically through on-board determination, or extrinsically through data sharing with a nearby device, and because content delivery network client 126 has a data connection to the content delivery network 100 (here, by way of network 118 and content delivery network server 102), content delivery network client 126 can share its location with content delivery network 100. The location awareness of content delivery network client 126 allows content delivery network 100 to provide location-based features for content delivery network client 126, such as location-based, targeted advertising. For example, content delivery network 100 could deliver finely targeted advertisements, such as neighborhood-based advertisements, or even proximity-based advertisements (e.g., to a nearby restaurant or service provider). Notably, if content delivery network client 126 was not able to determine its location, then content delivery network 100 would be limited to location-based advertising based on, for example, the known region of broadcast tower 144. Because regions may cover large geographic areas (e.g., an entire city), any targeted advertising based on that region would be coarse at best.

Content delivery network client 126 also includes a playback subsystem 134 that may be configured to control the playback of content such as television programming, Internet video clips, on-demand movies, streaming radio, etc. Playback subsystem 134 may include physical interfaces to external viewing and/or listening equipment, such as interfaces for connection to a television or an AV receiver or the like. The audio and/or video interfaces may comprise, for example, an HDMI interface, a coaxial interface, a composite interface, a component interface, an S-Video interface, an optical interface, a DisplayPort interface, a VGA interface, a DVI interface, and other interfaces.

Content delivery network client 126 also includes a user interface 136 that may be configured to interact with a user device, such as a remote control, personal electronic device, smart device (e.g., smartphone), tablet, computer, or the like, in order to execute commands and requests of a user. The user interface may enable a user to select content, enter preferences, enter ratings, schedule recordings, view content, view advertisements, etc.

Content delivery network client 126 also includes a tuner 138 that may be configured to receive linear content from the content delivery network via transmissions from broadcast tower 144. For example, tuner 138 may receive and decode ATSC digital television transmissions from broadcast tower 144. As indicated by arrow 142, the transmission of data from broadcast tower 144 to content delivery network client 126 is one-way or unidirectional. Accordingly, without more, targeted advertisement content transmitted over-the-air to content delivery network client 126 would normally be based on the location of broadcast tower 144. As above, because broadcast towers may have significant transmission ranges (e.g., 10s of miles), the targeted advertisements will at best be based on coarse geographical data.

Note that while a single tuner 138 is shown in FIG. 1, content delivery network client 126 may have a plurality of tuners.

In the content delivery network 100 depicted in FIG. 1, content is distributed from content delivery network server 102 to broadcast tower 144 via data link 140, which may be, for example, a fiber data link. The content is then delivered to content delivery network client 126 via over-the-air transmission, which is received by tuner 138 in content delivery network client 126. In other embodiments, the over-the-air transmission may be from a satellite instead of a terrestrial broadcast tower, or via a microwave transmission system, or via other types of over-the-air transmission systems. In addition to content, such as program content and advertisement content, content delivery network client 126 may also receive operational data via the over-the-air transmissions from broadcast tower 144, such as manifest files, software, firmware, program guide information, and other types of operational data.

Because content delivery network client 126 has a data connection with content delivery network server 102 via gateway 122 (e.g., a residential gateway or modem) and network 118 (e.g., the Internet) over data links 124, 120, and 116, content delivery network client 126 is able share data with content delivery network server 102 and thereby content delivery network 100. In some embodiments, the various data links are IP-based data links, such as TCP/IP network connections.

While the data connection between content delivery network client 126 and content delivery network 100 is via content delivery network server 102 in FIG. 1, this is only one example. In fact, content delivery network client 126 may have multiple different connections to multiple different elements of content delivery network 100, which serve different purposes, such as: a dedicated connection to a program content server, a dedicated connection to an advertisement content server, a dedicated connection to an analytics server, etc. In some embodiments, these dedicated connections may be in the form of distinct URLs to each respective element of content delivery network 100. The depiction in FIG. 1 is meant for simplicity and not as a limitation on the implementation.

One type of data that content delivery network client 126 may share with content delivery network 100 is location data. For example, content delivery network client 126 may determine its location by querying gateway 122 for its location. Because many gateways are location-aware, gateway 122 can share its location data with content delivery network client 126. The location data may include, for example, latitude and longitude data, address data, or other types of geographic metadata. In some embodiments, the location data provided by gateway 122 may be raw or unrefined location data, such as raw GPS measurement data, which geographic information system 132 may then resolve into refined location data, such as a residential address. In yet other embodiments, content delivery network client 126 may share raw or unrefined location data with content delivery network server 102 such that geographic information subsystem 106 can resolve the data into refined location data, such as a residential address or the like.

Another type of data content delivery network client 126 may share with content delivery network 100 is user or operational data. For example, content delivery network client 126 may report to analytics subsystem 108: user ratings for content; records of content that is selected and consumed by users; records of content that is ignored by users in process of finding content which is ultimately selected and consumed; records of content subscribed to on a regular basis; records of program content requested for one time viewing; and others.

In some embodiments, location data and/or user data is shared between content delivery network client 126 and content delivery network 100 by way of manifest files. For example, content delivery network 100 may provide content delivery network client 126 with an initial manifest file. Thereafter, content delivery network client 126 may update or modify the manifest file and share the updated or modified manifest file with content delivery network 100. The updated or modified manifest file may include location data regarding content delivery network client 126, such that content delivery network 100 may then select finely targeted advertisement content for content delivery network client 126. For example, content delivery network may deliver advertisement content related to local (i.e., nearby) business (e.g., restaurants) and service based on the location of content delivery network client 126.

Targeted advertisement content provided by content delivery network 100 may be further refined by considering location data and user data related to content delivery network client 126 concurrently. For example, content delivery network 100 may deliver finely targeted advertisement content to content delivery network client 126 related to a specific type of local business, such as a specific type of restaurant, based on, for example, a user watching a show about a certain type of food.

Accordingly, by sharing location and user data between content delivery network client 126 and content delivery network 100, content delivery network 100 can deliver finely targeted advertisement content to content delivery network client 126. Further, manifest files may be a conduit of the data exchange between content delivery network client 126 and content delivery network 100, which is advantageous because existing standards and protocols for processing of manifest files exist already.

Content delivery network client 126 may receive the finely targeted advertisement content from content delivery network 100 via, for example, a network connection such as network 118, and thereafter replace existing advertisement content delivered with the over-the-air with program content, for example from broadcast tower 144, using an advertisement content subsystem as described above (but not depicted in FIG. 1). In this way, content delivery network 100 may deliver coarse targeted advertisement content to all over-the-air users, and finely targeted advertisement content to users with location-aware content delivery network client, such as described above. This ensures that placement opportunities are always utilized during content delivery.

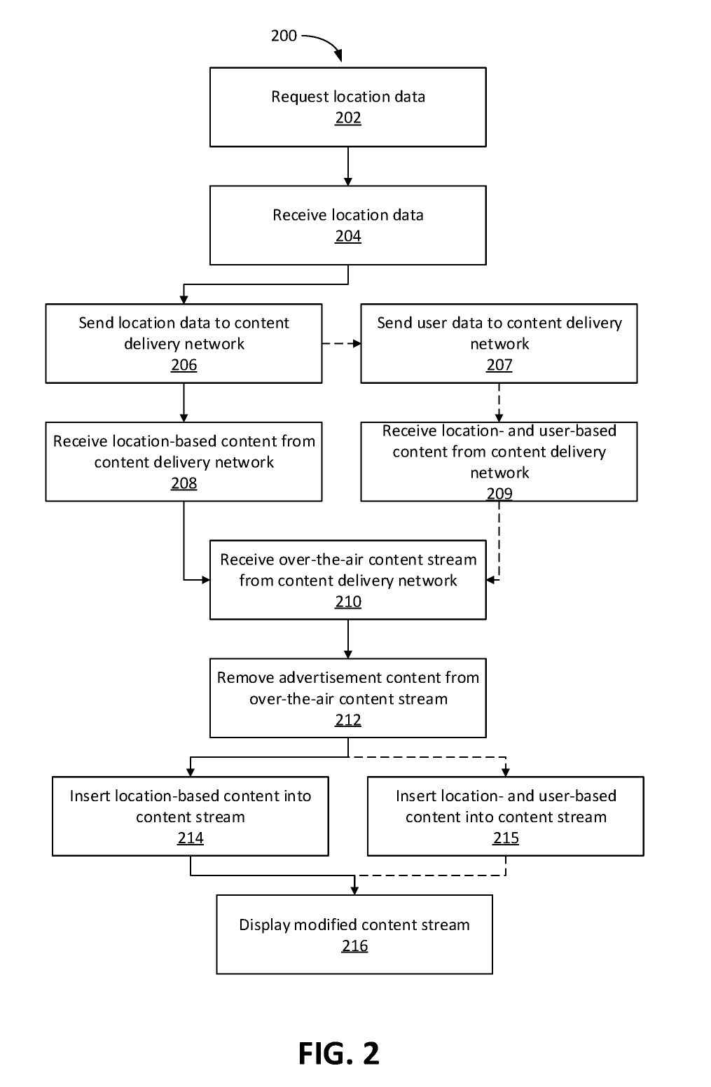

FIG. 2 depicts an example of a method 200 that may be implemented by a content delivery network client in a content delivery network, such as a set-top box.

The method 200 begins at step 202 where a content delivery network client requests location data. In some embodiments, the content delivery network client may request location data from an on-board system, such as an on-board GPS system. In other embodiments, the content delivery network client may request location data from a remote device, such as a device on a common network, such as a local area network. For example, the content delivery network client may request location data from a network device known to be location-aware, such as a network modem or a gateway. In yet other embodiments, the content delivery network client may request location data from a networked location server on a local or wide area network.

The method 200 then progresses to step 204 where the content delivery network client receives location data. The received location data may comprise geographical identification metadata, such as a geotag, geostamp, or the like, or other forms of geospatial metadata. The location data may include, for example, latitude and longitude coordinates, altitude, accuracy data, place names, and time stamps. In some embodiments, the location data may be in the form of raw GPS data or in the form of refined address data, such as a street address. In other embodiments, the location data may include regional identifiers based on regional definitions provided by the content delivery network.

The method 200 then progresses to step 206 where the content delivery network client sends the location date to the content delivery network. In some embodiments, the content delivery network client sends the location data to the content delivery network via a network connection, such as a wired or wireless connection to a wide area network like the Internet. In some embodiments, the location data may traverse the same network device that provided the content delivery network client the location data in the first place, such as a modem, router, or gateway.

After step 206, the method 200 may progress to step 208 where the content delivery network client receives location-based content from the content delivery network. In some embodiments, the location-based content may include location-based (i.e., targeted) advertisement. In other embodiments, the location-based content may alternatively or additionally include location-based promotional content.

After step 206, the method 200 may alternatively (as indicated by the broken arrow) progress to step 207 where the content delivery network client sends user or operational data to the content delivery network. User or operational data may include, for example: ratings for content; records of content that is selected and consumed by users; records of content that is ignored by users in process of finding content which is ultimately selected and consumed; records of content subscribed to on a regular basis; records of program content requested for one time viewing; and others.

After step 207, the method 200 progresses to step 209 where the content delivery network client receives location- and user-based content from the content delivery network. In some embodiments, the location- and user-based content may include location-based (i.e., targeted) advertisement content that is additionally selected based on user preferences. In other embodiments, the location- and user-based content may alternatively or additionally include location- and user-based promotional content.

After step 208 or 209, the method 200 progresses to step 210, where the content delivery network client receives an over-the-air content stream from the content delivery network. In some embodiments, the over-the-air content stream may be received from a terrestrial broadcast tower, while in other embodiments the over-the-air content stream may be received from a satellite broadcast network. The over-the-air content stream may comprise, for example, program content as well as original advertisement content (e.g., advertisement content injected into the content stream by the content delivery network).

The method 200 then progresses to step 212 where the content delivery network client removes advertisement content from the over-the-air content stream. In some embodiments, the content delivery network client may remove all advertisement content from the over-the-air content stream, while in other embodiments the content delivery network client may only remove selected advertisement content from the over-the-air content stream. In some embodiments, the content delivery network client may choose to remove selected advertisement content based on metadata associated with the selected advertisement content. In some embodiments, the metadata associated with the selected advertisement content is received by the content delivery network client in a manifest file (not shown) from the content delivery network.

After step 212, the method 200 may progress to step 214 where the content delivery network client inserts location-based content into the content stream and thereby forms a modified content stream. For example, the modified content stream may include one or more segments of location-based content received from the content delivery network. In some embodiments, all of the advertisement content in the resulting modified content stream may be location-based, while in other embodiments, only some of the advertisement content in the modified content stream is location-based.

After step 212, the method 200 may alternatively (as indicated by the broken arrow) progress to step 215 where the content delivery network client inserts location- and user-based content into the content stream and thereby forms a modified content stream. For example, the modified content stream may include one or more segments of location- and user-based content received from the content delivery network. In some embodiments, all of the advertisement content in the resulting modified content stream may be location- and user-based, while in other embodiments, only some of the advertisement content in the modified content stream is location- and user-based.

After step 214 or 215, the method 200 progresses to step 216 where the content delivery network client displays the modified content stream. For example, the content delivery network client may playback the modified content stream on a connected display device, such as a monitor or a television.

In another alternative embodiment of method 200 (not shown), the content delivery network client may only receive user-based content from the content delivery network. In such an embodiment, the original content stream may likewise be modified to remove included advertisement content and to replace it with user-based advertisement content.

In another alternative embodiment of method 200 (not shown), the content delivery network client may store the modified content stream in local storage for later playback. For example, the content delivery network client may receive the over-the-air content, receive location-based content, modify the content stream with the location-based content, and then store the modified content stream for later display, such as in a digital video recorder (DVR) service.

In another alternative embodiment of method 200 (not shown), the content delivery network client may receive the original content stream over the network (e.g., via streaming, also referred to as “over-the-top”) instead of over-the-air. In such an embodiment, the stream may likewise be modified to remove included advertisement content and to replace it with location- and/or user-based advertisement content.

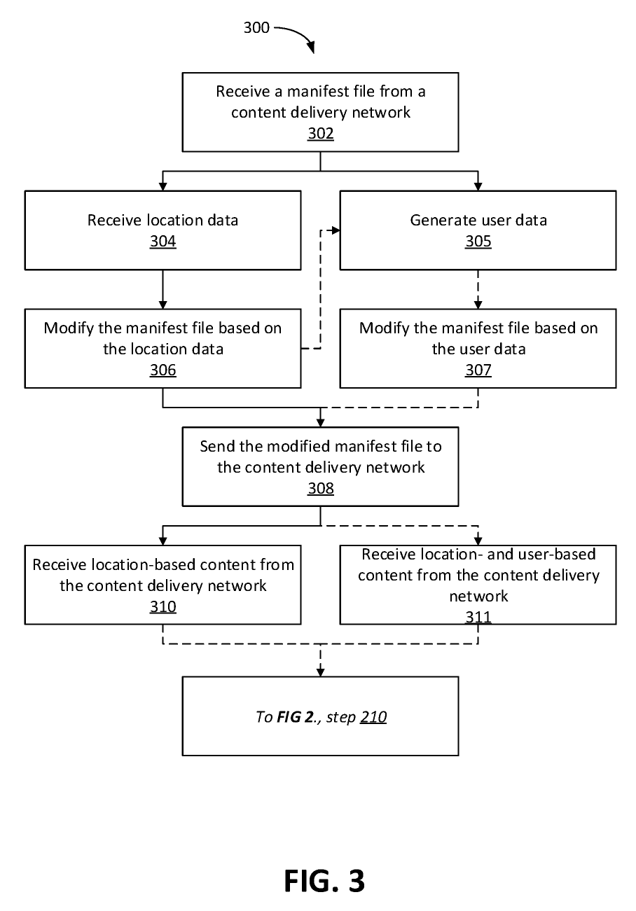

FIG. 3 depicts an example of a method 300 that may be implemented by a content delivery network client in a content delivery network, such as a set-top box.

The method 300 begins at step 302 where a content delivery network client, such as a set-top box, receives a manifest file from a content delivery network. The manifest file may comprise a listing or index of what is contained in each of the segments of a content stream provided to the content delivery network client by the content delivery network.

The method 300 then progresses to step 304, where the content delivery network client receives location data. This step may be performed, for example, in the manner described with respect to step 204 of FIG. 2, above.

The method 300 then progresses to step 306 where the content delivery network client modifies the manifest file based on the location data. For example, the content delivery network client may modify the manifest file to include location data or locations determined based on that data (e.g., a particular city, neighborhood, location, etc.).

After step 306, the method 300 may optionally progress to step 305 (as indicated by broken arrow) where the content delivery network client generates user data. User data may include, for example, viewing behavior, subscriptions for linear and nonlinear content, explicit requests by the viewer to record specific linear content, explicit requests by the user to capture specific nonlinear content, and explicit ratings for specific content, among others.

From step 305, the method 300 progresses to step 307 where the content delivery network client modifies the manifest file based on the user data. For example, the content delivery network client may modify the manifest file to show which segments of a content stream have been selected and viewed by a user.

After step 306 or 307, the method progresses to step 308 where the content delivery network client sends a modified manifest file to the content delivery network. The content delivery network client may send the modified manifest file via a network, such as network 118 in FIG. 1.

If the content delivery network client only modified the manifest file based on location data (step 306), then the method 300 progresses to step 310 where the content delivery network client receives location-based content from the content delivery network. For example, the location-based content may comprise location-based advertisement or promotional content.

If the content delivery network client also modified the manifest file based on user data (step 307), then the method 300 progresses to step 311 where the content delivery network client receives location- and user-based content from the content delivery network. For example, the location- and user-based content may comprise location- and user-based advertisement or promotional content.

After step 310 or 311, the method may optionally (as shown with broken arrows) progress as described with respect to FIG. 2 at step 210 and thereafter.

In an alternative embodiment of method 300 (not shown), the content delivery network may only receive user data from the content delivery network client. In such an embodiment, the content delivery network client would then only receive user-based content from the content delivery network.

Persons of skill in the art will appreciate that the specific embodiments described herein are exemplary only, and other embodiments with other combinations of the features described herein are possible and within the scope of this disclosure.

1. A method of enabling location-based services in a content delivery network client connected to a network, comprising:
requesting location data from a device on the network;
receiving location data from the device on the network;
receiving a manifest file from a content delivery network via the network;
storing the manifest file in a memory of the content delivery network client;
modifying the manifest file stored in the memory of the content delivery network client based on the received location data from the device on the network;
sending a modified manifest file to the content delivery network via the network;
receiving location-based content based on the modified manifest file from the content delivery network via the network; and
receiving an over-the-air content stream from the content delivery network, the over-the air content stream comprising:
program content; and
original advertisement content.

2. (canceled)

3. The method of claim 1, further comprising:
generating user data based on a status of the content delivery network client;
sending the user data to the content delivery network via the network,
wherein the location-based content received from the content delivery network is also based on the user data.

4. The method of claim 3, wherein modifying the manifest file stored in the memory of the content delivery network client further comprises modifying the manifest file based on the generated user data.

5. The method of claim 1, wherein the location-based content is location-based advertisement content.

6. The method of claim 1, wherein receiving the over-the-air content stream from the content delivery network further comprises: receiving the over-the-air content stream from a terrestrial broadcast tower.

7. The method of claim 1, wherein receiving the over-the-air content stream from the content delivery network further comprises: receiving the over-the-air content stream from a satellite broadcast.

8. The method of claim 1, wherein the device on the network is one of a modem, a gateway, or a router.

9. The method of claim 5, further comprising:
generating a modified content stream by inserting the location-based advertisement content into the over-the-air content stream; and
displaying the modified content stream.

10. The method of claim 9, further comprising: removing the original advertisement content from the over-the-air content stream.

11. The method of claim 1, wherein the content delivery network client comprises a set-top box.

12. A content delivery network client for providing location-based content in a content delivery network, comprising:
a processor;
a tuner;
a network interface; and
a memory comprising software,
wherein, the processor is configured to execute the software and cause the content delivery network client to:
request location data via the network interface from a device on a network;
receive location data via the network interface from the device on the network;
receive a manifest file from a content delivery network via the network interface;
store the manifest file in the memory;
modify the manifest file stored in the memory based on the received location data from the device on the network;
send a modified manifest file to the content delivery network via the network interface;
receive location-based content based on the modified manifest file from the content delivery network via the network interface; and
receive an over-the-air content stream from the content delivery network via the tuner, the over-the air content stream comprising:
program content; and
original advertisement content.

13. (canceled)

14. The content delivery network client of claim 12, wherein the processor is configured to execute the software and further cause the content delivery network client to:
generate user data based on a status of the content delivery network client;
send the user data to the content delivery network via the network interface,
wherein the location-based content received from the content delivery network is also based on the user data.

15. The content delivery network client of claim 14, wherein the processor is configured to execute the software and further cause the content delivery network client to: modify the manifest file stored in the memory based on the generated user data.

16. The content delivery network client of claim 12, wherein the location-based content is location-based advertisement content.

17. The content delivery network client of claim 12, wherein the processor is configured to execute the software and further cause the content delivery network client to: receive the over-the-air content stream via the tuner from a terrestrial broadcast tower.

18. The content delivery network client of claim 12, wherein the processor is configured to execute the software and further cause the content delivery network client to: receive the over-the-air content stream from a satellite broadcast.

19. The content delivery network client of claim 16, wherein the processor is configured to execute the software and further cause the content delivery network client to:
generate a modified content stream by inserting the location-based advertisement content into the over-the-air content stream; and
display the modified content stream.

20. The content delivery network client of claim 12, wherein the content delivery network client comprises a set-top box.
